(19) United States
(12) Patent Application Publication
(10) Pub. No.: US 2003/0159567 A1
(43) Pub. Date: Aug. 28, 2003

(54) Interactive music playback system utilizing gestures

(76) Inventor: Morton Subotnick, New York, NY (US)

Correspondence Address: David Leason, Darby & Darby, Post Office Box 5257, NewYork, NY, 10150-5257, US

(21) Appl. No.: 10/258,059

(22) PCT Filed: Apr. 17, 2001
(86) PCT No.: PCT/US01/40539

(51) Int. Cl. G10H 1/02; G10H 1/36; G10H 7/00; G01P 3/00

(52) U.S. Cl. 84/626; 84/610

(57) ABSTRACT

An interactive music system (10) in accordance with various aspects of the invention lets a user control the playback of recorded music according to gestures entered via an input device (14), such as a mouse. The system includes modules which interpret input gestures made on a computer input device and adjust the playback of audio data in accordance with input gesture data. Various methods for encoding sound information in an audio data produce with meta-data indicating how it can be varied during playback are also disclosed. More specifically, a gesture input system receives user input from a device, such as a mouse, and interprets this data as one of a number of predefined gestures which are assigned an emotional or interpretive meaning according to a “character” hierarchy or library (16) of gesture descriptions. The received gesture inputs are used to alter the character of music which is being played in accordance with the meaning of the gesture. For example, an excited gesture can effect the playback in one way, while a quiet playback may affect it in another. The specific result is a combination of the gesture made by the user, its interpretation by the computer, and a determination of how the interpreted gesture should effect the playback. Entry of a excited gesture thus may brighten the playback, e.g., by changing increasing the tempo, changing from a minor to major key, varying the instruments used or the style in which they are played, etc. In addition, the effects can be cumulative, allowing a user to progressively alter the playback. To further enhance the interactive nature of the system, users can be given the ability to alter the effect of a given gesture or assign a gesture to specific places in the character hierarchy.

### RELATED APPLICATIONS

The present application relates to, and claims priority of, U.S. Provisional Patent Application Serial No. 60/197,498 filed on Apr. 18, 2000, commonly assigned to the same assignee as the present application and having the same title which is also incorporated herein by reference.

### FIELD OF THE INVENTION

This invention relates to music playback systems and, more particularly, to a music playback system which interactively alters the character of the played music in accordance with user input.

### DESCRIPTION OF THE RELATED ART

Prior to the widespread availability of the prerecorded music, playing music was generally an interactive activity. Families and friends would gather around a piano and play popular songs. Because of the spontaneous nature of these activities, it was easy to alter the character and emotional quality of the music to suit the present mood of the pianist and in response to the reaction of others present. However, as the prevalence of broadcast and pre-recorded music became widespread, the interactive nature of in-home music slowly diminished. At present, the vast majority of music which is played is pre-recorded. While consumers have access to a vast array of recordings, via records, tapes, CD and Internet downloads, the music itself is fixed in nature and the playback of any given piece is the same each time it is played.

Some isolated attempts to produce interactive media products have been made in the art. These interactive systems are generally of the form of a virtual mixing studio in which a user can re-mix music from a set of prerecorded audio tracks or compose music by selecting from a set of audio riffs using a pick-and-choose software tool. Although these systems in the art allow the user to make fairly complex compositions, they do not interpret user input to produce the output. Instead, they are manual in nature and the output has a one-to-one relationship to the user inputs.

Accordingly, there is a need to provide an interactive musical playback system which responds to user input to dynamically alter the music playback. There is also a need to provide an intuitive interface to such a system which provides a flexible way to control and alter playback in accordance with a user's emotional state.

### SUMMARY OF THE INVENTION

An interactive music system in accordance with various aspects of the invention lets a user control the playback of recorded music according to gestures entered via an input device, such as a mouse. The system includes modules which interpret input gestures made on a computer input device and adjust the playback of audio data in accordance with input gesture data. Various methods for encoding sound information in an audio data product with meta-data indicating how it can be varied during playback are also disclosed.

More specifically, a gesture input system receives user input from a device, such as a mouse, and interprets this data as one of a number of predefined gestures which are assigned an emotional or interpretive meaning according to a “character” hierarchy or library of gesture descriptions. The received gesture inputs are used to alter the character of music which is being played in accordance with the meaning of the gesture. For example, an excited gesture can effect the playback in one way, while a quiet playback may affect it in another. The specific result is a combination of the gesture made by the user, its interpretation by the computer, and a determination of how the interpreted gesture should effect the playback. Entry of a excited gesture thus may brighten the playback, e.g., by changing increasing the tempo, changing from a minor to major key, varying the instruments used for the style in which they are played, etc. In addition, the effects can be cumulative, allowing a user to progressively alter the playback. To further enhance the interactive nature of the system, users can be given the ability to alter the effect of a given gesture or assign a gesture to specific places in the character hierarchy.

In a first playback embodiment, the system uses gestures to select music to play back from one of a set of prerecorded tracks or musical segments. Each segment has associated data which identifies the emotional content of the segment. The system can use the data to select which segments to play and in what order and dynamically adjust the playback sequence in response to the received gestures. With a sufficiently rich set of musical segments, a user can control the playback from soft and slow to fast and loud to anything in between as often as for as long as they wish. The degree to which the system reacts to gestural user input can be varied from very responsive, wherein each gesture directly selects the next segment to play, to only generally responsive where, for example, the system presents an entire composition including multiple segments related to a first received gesture and subsequent additional gestures alter or color the same composition instead of initiating a switch to new or other pieces of music.

According to another aspect of the system, the music (or other sound) input is not fixed but is instead encoded, e.g., in a Musical Instrument Digital Interface (MIDI) format, perhaps with various indicators which are used to determine how the music can be changed in response to various gestures. Because the audio information is not prerecorded, the system can alter the underlying composition of the musical piece itself, as opposed to selecting from generally unchangeable audio segments. The degree of complexity of the interactive meta-data can vary depending on the application and the desired degree of control.

### BRIEF DESCRIPTION OF THE DRAWINGS

The foregoing and other features of the present invention will be more readily apparent from the following detailed description and drawings of illustrative embodiments of the invention, not necessarily dawn to scale, in which:

FIG. 1 is a block diagram of a system for implementing the present invention;

FIG. 2 is a flowchart illustrating one method for interpreting gestural input;

FIG. 3 is a flowchart illustrating operation of the playback system in “DJ” mode;

FIG. 4 is a flowchart illustrating operating of the playback system in “single composition mode”; and

FIG. 5 is a diagram illustrating an audio exploration feature of the present invention.

### DETAILED DESCRIPTION OF THE PREFERRED EMBODIMENTS

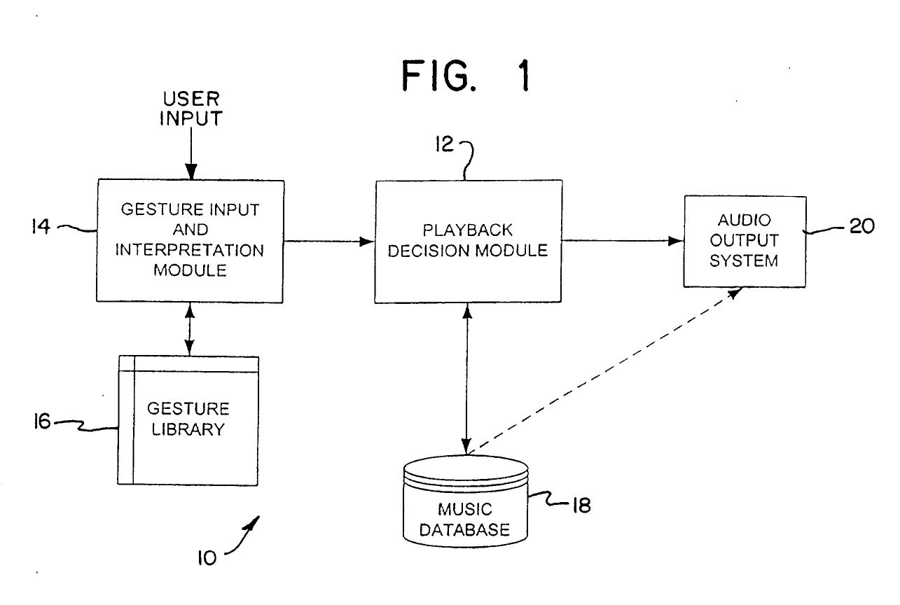

Turning to FIG. 1, there is shown a high-level diagram of an interactive music playback system 10. The system 19 can be implemented in software on a general purpose or specialized computer and comprises a number of separate program modules. The music playback is controlled by a playback module 12. A gesture input module 14 receives and characterizes gestures entered by a user and makes this information available to the playback module 12. Various types of user-input systems can be used to capture the basic gesture information. In a preferred embodiment, a conventional two-dimensional input device is used, such as a mouse, joystick, trackball, or tablet (all of which are generally referred to as a mouse or mouse-like device in the following discussion). However any other suitable device or combination of input devices can be used, including data gloves, and electronic conducting baton, optical systems, such as video motion tracking systems, or even devices which register biophysical data, such as blood pressure, heart rate, or muscle tracking systems.

The meaning attributed to a specific gesture can be determined with reference to data stored in a gesture library 16 and is used by the playback module 12 to appropriately select or alter the playback of music contained in the music database 18. The gesture-controlled music is then output via an appropriate audio system 20. The various subsystems will be discussed in more detail below.

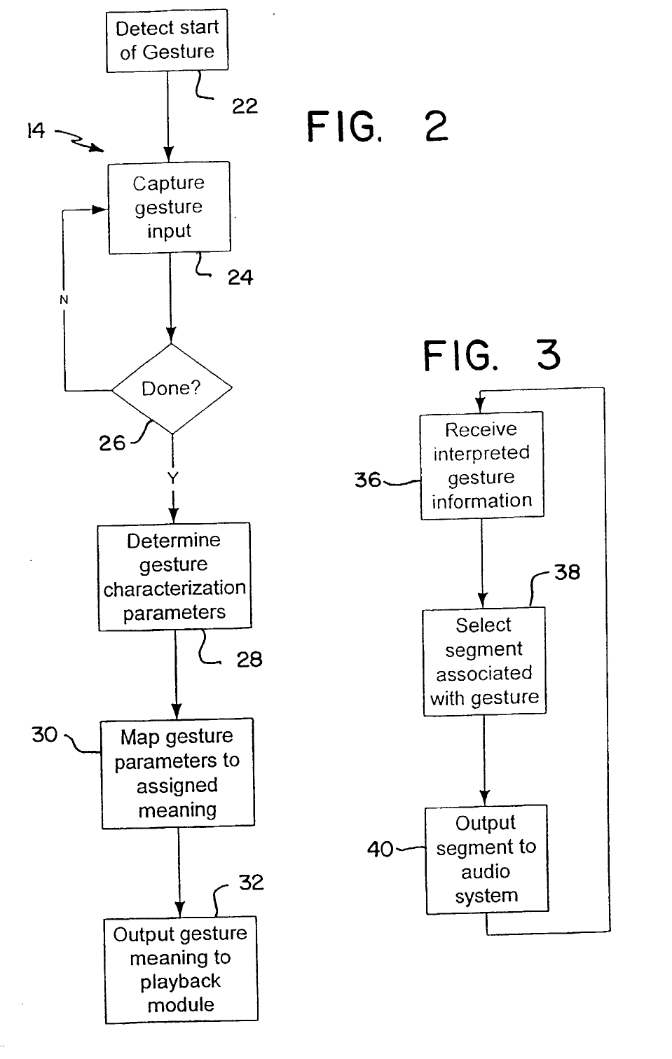

FIG. 2 is a flowchart illustration the general operation of one embodiment of the gesture input module 14. The specific technique used to implement the module depends upon the computing environment and the gesture input device(s) used. In a preferred embodiment, the module is implemented using a conventional high-level programming language or integrated environment.

Initially, the beginning of a gesture is detected. (Step 22). In the preferred mouse-input implementation, a gesture is initiated by depressing a mouse button. When the mouse button depression is detected, the system begins to capture the mouse movement. (Step 24). This continues until the gesture is completed (step 26), as signaled, e.g., by a release of the mouse button. Various other starting and ending conditions can alternatively be used, such as the detection of the start and end of input motions generally or motions which exceed a specified speed or distance threshold.

During the gesture capture period, the raw gesture input is stored. After the gesture is completed, the captured data is analyzed, perhaps with reference to data in the gesture library 16, to produce one or more gesture characterization parameters (step 28). Alternatively, the input gesture data can be analyzed concurrently with capture and the analysis completed when the gesture ends.

Various gesture parameters can be generated from the raw gesture data. The specific parameters which are generated depend on how the gesture input is received and the number of general gestures which are recognized. In a preferred embodiment based on mouse-input gesture, the input gesture data is distilled into values which indicate overall bentness, jerkiness, and length of the input. These parameters can be generated in several ways.

In one implementation the raw input data is first used to calculate (a) the duration of time between the MouseDown and the MouseUP signals, (b) the total length of the line created by the mouse during capture time (e.g., the number of pixels traveled), (c) The average speed (velocity) of the mouse movement, (d) variations in mouse velocity within the gesture, and (e) the general direction or aim of the mouse movement throughout the gesture, perhaps at rough levels of precision, such as N, NE E, SE, S, SW, W, and NW.

The aim data is used to determine the number and possibly location of horizontal and vertical direction changes present in the gesture, which is used to determine the number of times the mouse track make significant direction changes during the gesture. This value is then used as an indication of the bentness of the gesture. The total bentness value can be output directly. To simplify the analysis, however, the value can be scaled, e.g., to a value of 1-10, perhaps with reference to the number of bends per unit length of the mouse track. For example, a bentness value of 1 can indicate a substantially straight line while a bentness value of 10 indicates that the line very bent. Such scaling permits the bentness of differently sized gestures to be more easily compared.

In a second valuation (which is less precise but easier to work with), bentness can simply be characterized one a 1-3 scale, representing little bentness, medium bentness, and very bent, respectively. In a very simple embodiment, if there is no significant change of direction (either horizontally or vertically), the gesture has substantially no bentness e.g., bentness=1. Medium bentness can represent a gesture one major direction change, either horizontal or vertical (bentness=2). If there are two or more changes in direction, the gesture is considered very bent (bentness=3).

The changes in the speed of the gesture can also be analyzed to determine the number of times the mouse changes velocity over the course of the gesture input. This value can then be used to indicate the jerkiness or jaggedness of the input. Preferably, jerkiness is scaled in a similar manner as bentness, such as a 1-10 scale of little jerkiness, some jerkiness, and very jerky (e.g., a 1-3 scale). Similarly, the net overall speed and length of the gesture can also be represented as general values of slow, medium, fast and short, medium, or long, respectively.

For the various parameters, the degree of change required to register a change in direction or change in speed can be predefined or set by the user. For example a minimum speed threshold can be established wherein motion below the threshold is considered equivalent to being stationary. Further, speed values can be quantized across specific ranges and represented as integral multiples of the threshold value. Using this scheme, the general shape or contour of the gesture can be quantified by two basic parameters—its bentness and length. Further quantification is obtained by additionally considering a gesture's jerkiness and average speed, parameters which indicate how the gesture was made, as opposed to what it look like.

Once the gesture parameters are determined, these parameters are used to define a specific value or attribute to the gesture, which value can be mapped directly to an assigned meaning, such as an emotional attribute. There are various techniques which can be used to combine and map the gesture parameters. Gesture characterization according to above technique results in a fixed number of gestures according to the granularity of the parameterization process.

In one implementation of this method, bentness and jerkiness are combined to form a general mood or emotional attribute indicator. This indicator is than scaled according to the speed and/or length of the gesture. The resulting combination of values can be associated with an “emotional” quality which is used to determine how a given gesture should effect musical playback. As shown in FIG. 1, this association can be stored in a gesture library 16 which can be implemented as simple lookup table. Preferably, the assignments are adjustable by the user and can be defined during an initial training or setup procedure.

For example, Jerkiness=1 and Bentness 1 can indicate “Max gentle, Jerkiness=2 and Bentness-2=can indicated “less gentle”, Jerkiness=3 and Bentness=3 can indicate “somewhat aggressive”, and Jerkiness=4 and Bentness=4 can indicate “very aggressive”. Various additional general attributes can be specified for situations where bentness and jerkiness are now equal. Further, each general attribute are scaled according to the speed and/or length of the gesture. For example, if only length of values for 1-4 are considered, each general attribute can have four different scales in accordance with the gesture length, such as “max gentle” through “max gentle 4”.

As will be recognized by those of skill in the art, using this scheme, even a small number of attributes can be combined t defined a very large number of gestures. Depending on the type of music and the desired end result, the number of gestures can be reduced, fo example to two states, such as gentle vs aggressive, and two or three degrees or scales for each. In another embodiment, a simple set of 16 gestures can be defined specifying two values for each parameter, e.g., straight or bent, smooth or jerky, fast or slow, and long or short, and defining the gestures as a combination of each parameter.

According to the above methods, the gestures are defined discretely, e.g., there are a fixed total number of gestures. In an alternative embodiment, the gesture recognition process can be performed with the aid of an untrained neural network, a network with a default training, or other types of “artificial intelligence” routines. In such an embodiment, a user can train the system to recognize a users unique gestures and associate these gestures with various emotional qualities or attributes. Various training techniques are known to those of skill in the art and the specific implementations used can vary according to design considerations. In addition, while the preferred implementation relies upon only a single gesture input device, such as a mouse, gesture training (as opposed to post-training operation) can include other types of data input, particularly when a neutral network is used a part of the gesture recognition system. For example, the system can receive biomedical input, such as pulse rate, blood pressure, EEG and EKG data, etc., for use in distinguishing between different types of gestures and associating them with specific emotional states.

As will be appreciated by those of skill in the art, the specific implementation and sophistication of the gesture mapping procedure and the various gesture parameters considered can vary according to the complexity of the application and the degree of playback control made available to the user. In addition, users can be given the option of defining gesture libraries of varying degrees of specificity. Regardless of how the gestures are captured and mapped, however, once a gesture has been received and interpreted, the gesture interpretation is used by the playback module (step 32) to alter the musical playback.

There are various methods of constructing a playback module 12 to adjust playback of musical data in accordance with gesture input. The musical data generally is stored in a music database, which can be a computer disc, a CD ROM, computer memory such as random access memory (RAM), networked storage systems, or any other generally randomly accessible storage device. The segments can be stored in any suitable format. Preferably, music segments are stored as digital sound files in formats such as AU, WAV, QT, or MP3. AU, short for audio, is a common format for sound files on UNIX machines, and the standard audio file format for the Java programming language. WAV is the format for storing sound in files developed jointly by Microsoft™ and IBM™, which is a de facto standard for sound files on Windows™ applications. QT, or QuickTime, is a standard format for multimedia content in Macintosh™ applications developed by Apple™. MP3, or MPEG Audio Layer-3, is a digital audio coding scheme used in distributing recorded music over the Internet.

Alternatively, musical segments can be stored in a Musical Instrument Digital Interface (MIDI) format wherein the structure of the music is defined but the actual audio must be generated by appropriate playback hardware. MIDI is a serial interface that allows for the connection of music synthesizers, musical instruments and computers

The degree to which the system reacts to received gestures can be varied. Depending on the implementation, the user can be given the ability to adjust the gesture responsiveness. The two general extremes of responsiveness will be discussed below as “DJ” mode and “single composition” mode.

In “DJ mode”, the system is the most responsive to received gestures, selecting a new musical segment to play for each gesture received. The playback module 12 outputs music to the audio system 20 which corresponds to each gesture received. In a simple embodiment, and with reference to the flowchart of FIG. 3, a plurality of musical segments are stored in the music database 18. Each segment is associated with a specific gesture, i.e., gentle, moderate, aggressive, soft, loud, etc. The segments do not need to be directly related to each other (as, for example, movements in a musical composition are related), but instead can be discrete musical or audio phrases, songs, etc (thus permitting the user act like a “DJ but using gestures to select appropriate songs to play, as opposed to identifying the songs specifically).

FIG. 3 is a flow diagram that illustrates operation of the playback system in “DJ” mode. As a gesture is received (step 36), the playback module 12 selects a segment which corresponds to the gesture (step 38) and ports it to the audio system 20 (step 40). If more than one segment is available, a specific segment can be selected at random or in accordance with a predefined or generated sequence. If a segment ends prior to the receipt of another gesture another segment corresponding to that gesture can be selected, the present segment can be repeated, or the playback terminated. If one or more gestures are received during the playback of a given segment, the playback module 12 preferably continuously revises the next segment selection in accordance with the received gestures and plays that segment when the first one completes. Alternatively, the presently playing segment can be terminated and the segment corresponding to the newly entered gesture started immediately or after only a short delay. In yet another alternative the system can queue the gestures for subsequent interpretation in sequence as each segment's play back completes. In this manner a user can easily request, for example, three exciting songs followed by a relaxed song by entering the appropriate four gestures. Advantageously, the user does not need to identify (or even know) the specific songs played for the system to make an intelligent and interpretative selection. Preferably, the user is permitted to specific the default behaviors in these various situations.

The association between audio segments and gesture meanings can be made in a number of ways. In one implementation, the gesture associated with a given segment, or at least the nature of segment, is indicated in a segment-tag a gesture “tag” which can be read by the playback system and used to determine when it is appropriate to play a given segment. The tag can be embedded within the segment data itself, e.g., within a header data or block, or reflected externally, e.g., as part of the segment's file name or file directory entry.

Tag data can also be assigned to given segments by means of a look-up table or other similar data structure stored within the playback system or audio library, which table can be easily updated as new segments are added to the library and modified by the user so that the segment-gesture or segment-emotion associations reflects their personal taste. Thus, for example, a music library containing a large number of songs may be provided and include an index which lists the songs available on the system and which defines the emotional quality of each piece.

In one exemplary implementation, downloadable audio files, such as MP3 files, can include a non-playable header data block which includes tag information recognized by the present system but in a form which does not interfere with conventional playback. The downloaded file can added to the audio library, at which time the tag is processed and the appropriate information added to the library index. For a preexisting library or compilation of audio files, such as may be present on a music compact disc (CD) or MP3 song library, an interactive system can be established which receives lists of audio files (such as songs) from a user, e.g., via e-mail or the Internet, and then returns an index file to the user containing appropriate tag information for the identified audio segments. With such an index file, a user can easily select a song having a desired emotional quality from a large library of musical pieces by entering appropriate emotional gestures without having detailed knowledge of the precise nature of each song in the library, or even the contents of the library.

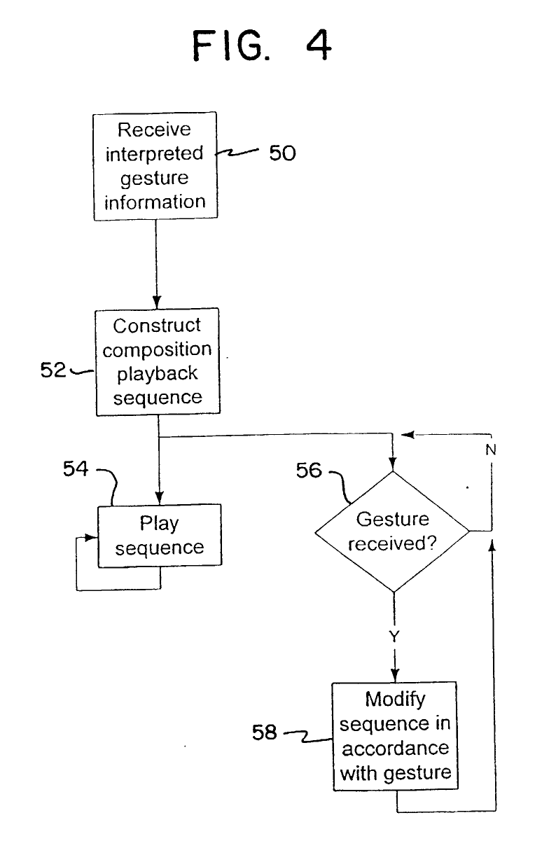

In “single composition mode”, the playback module 12 generates or selects an entire musical composition related to an initial composition and alters or colors the initial composition in accordance with subsequent gesture's meaning. One method for implementing this type of playback is illustrated in the flow chart of FIG. 4. A given composition is comprised of a plurality of sections or phrases. Each defined phrase or section of the music is given a designation, such as a name or number, and is assigned a particular emotional quality or otherwise associated with the various gestures or gesture attributes which can be received. Upon receipt of an initial gesture (step 50), the meaning of the gesture is used to construct a composition playback sequence which includes segments of the composition which are generally consistent with the initial gesture (step 52). For example, if the initial gesture is slow and gentle, the initial composition will be comprised of sections which also are generally slow and gentle. The selected segments in the composition are then output to the audio system (step 54).

Various techniques can be used to construct the initial composition sequence. In one embodiment, only those segments which directly correspond to the meaning of the received gesture are selected as elements in the composition sequence. In a more preferred embodiment, the segments are selected to provide an average or mean emotional content which corresponds to the received gesture. However, the pool of segments which can be added to the sequence is made of segments which vary from the meaning of the received gesture by no more than a defined amount, which amount can be predefined or selected by the user.

Once the set of segments corresponding to the initial gesture is identified, specific segments are selected to form a composition. The particular order of the segment sequence can be randomly generated, based on an initial or predefined ordering of the segments within the master composition, based on additional information which indicates which segments go well with each other, based on other information or a combination of various factors. Preferably a sequence of a number of segments is generated to produce the starting composition. During playback, the sequence can be looped and the selected segments combined in varying orders to provide for continuous and varying output.

After the initial composition sequence has been generated, the playback system uses subsequent gesture inputs to modify the sequence to reflect the meaning of the new gestures. For example, if an initial sequence is gentle and an aggressive gesture is subsequently entered, additional segments will be added to the playback sequence so that the music becomes more aggressive, perhaps getting louder, faster, increased vibrato, etc. Because the composition includes a number of segments, the transition between music corresponding to different gestures does not need to be abrupt, as in DJ mode, discussed above. Rather, various new segments can be added to the playback sequence and old ones phased out such that the average emotional content of the composition gradually transitions from one state to the next.

It should be noted that, depending on the degree of control over the individual segments which is available to the playback system, the manner in which specific segments themselves are played back can be altered in additional to or instead of selecting different segments to add to the playback. For example, a given segment can have a default quality of “very gentle”. However, by increasing the volume and/or speed at which the segment is played or introducing acoustic effects, such as flanging, echos, noise, distortions, vibrato, etc., its emotional quality can be made more aggressive or intense. Various digital signal processing tools known to those of skill in the art can be used to alter “prerecorded” audio to introduce these effects. For audio segments which are coded as MIDI data, the transformation can be made using MIDI software tools, such as Beatnick™. MIDI transformations can also include changes in the orchestration of the piece, e.g., by selecting different instruments to play various parts in accordance with the desired effect, such as using flutes for gentle music and trumpets for more aggressive tones.

To support this playback mode, a source composition must be provided which contains a plurality of audio segments which are defined as to name and/or position within an overall piece and have an associated gesture tag. In one contemplated embodiment, a customized composition is written and recorded specifically for use with the present system. In another environment, a conventional recording, such as a music CD has an associated index file which defines the segments on the CD, which segments do not need to correspond to CD tracks. The index file also defines a gesture tag for each segment. Although the segment definitions can be embedded within the audio data itself, a separate index file is easier to process and can be stored in a manner which does not interfere with playback of the composition using conventional systems.

The index file can also be provided separately from the initial source of the audio data. For example, a library of index files can be generated for various preexisting musical compositions, such as a collection of classical performances. The index files can then be downloaded as needed stored in, e.g., the music database, and used to control playback of the audio data in the manner discussed above.

In a more specific implementation, a stereo component, such as a CD player, can include an integrated gesture interpretation system. An appropriate gesture input, such as a joystick, mouse, touch pad, etc. is provided as an attachment to the component. A music library is connected to the component. If the component is a CD player, the library can comprise a multi-disk cartridge. Typical cartridges can contain one hundred or more separate CDs and thus “library” can have several thousand song selections available. Another type of library comprises a computer drive containing multiple MP3 or other audio files. Because of the large number of song titles available, the user may find it impossible to select songs which correspond to their present mood. In this specific implementation, the gesture system would maintain an index of the available songs and associated gesture tag information. (For the CD example, the index can be built by reading gesture tag data embedded within each CD and storing the data internally. If gesture tag data is not available, information about the loaded CDs can be gathered and then transmitted to a web server which returns the gesture tag data, if available). The user can then play the songs using the component simply by entering a gesture which reflects the type of music they feel like hearing. The system will then select appropriate music to play.

In an additional embodiment, gesture-segment associations can be hard-coded in the playback system software itself wherein, for example, the interpretation of a gesture inherently provides the identification of one segments or a set of segments to be played back. This alternative embodiment is well suited for environments where the set of available audio segments are predefined and are generally not frequently updated or added to by the user. One such environment is present in electronic gaming environments, such as computer or video games, particularly those having “immersive” game play. The manner in which a user interacts with the game, e.g., via a mouse, can be monitored and that input characterized in a manner akin to gesture input. The audio soundtrack accompanying the game play can then be adjusted according to emotional characteristics present in the input.

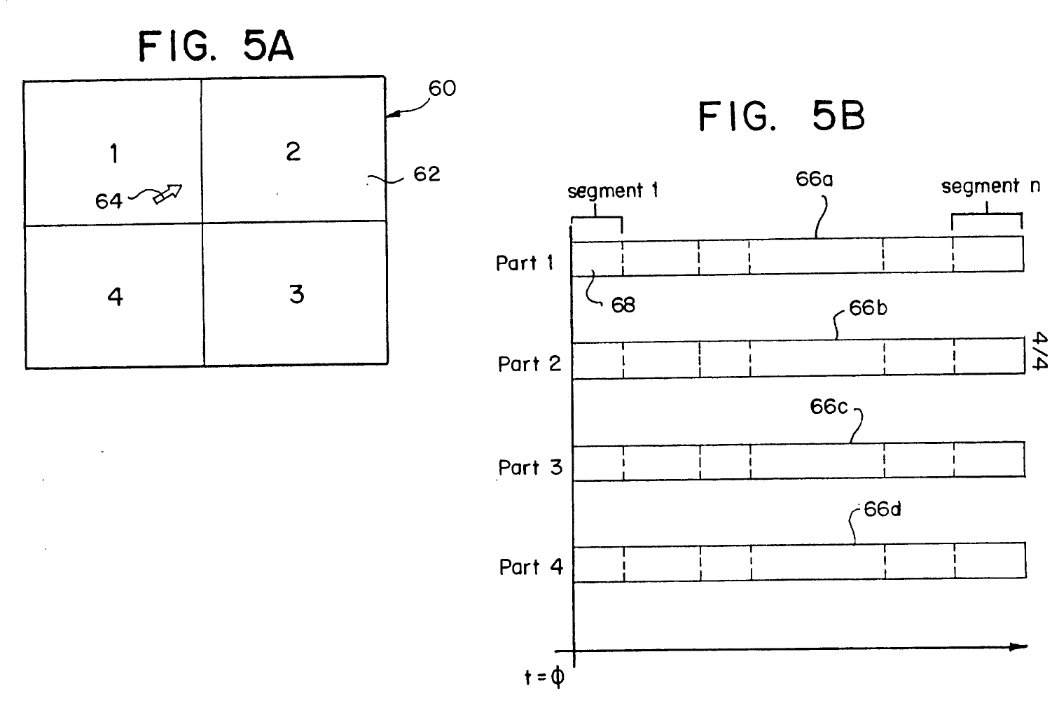

According to a further aspect of the invention, in addition to using gestures to select the specific musical segments which are played, a non-gesture mode can also be provided in which the user can explore a piece of music. With reference FIG. 5, a composition is provided as a plurality of parts, such as parts 66a-66d, each of which is synchronized with each other, e.g., by starting playback at the same time. Each part represents a separate element of the music, such as vocals, percussive, bass, etc.

In this aspect of the system, each defined part is played internally simultaneously and the user input is monitored for non-gesture motions. These motions can be in the form of, e.g., moving a curser 64 within areas 62 of a computer display 60. Each area of the display is associated with a respective part. The system mixes the various parts according to where the cursor is located on the screen. For example, the vocal aspects of the music can be most prevalent in the upper left corner while the percussion is most prevalent in the lower right. By moving the cursor around the screen, the user can explore the composition at will. In addition, the various parts can be further divided into parallel gesture-tagged segments 68. When a gesture based input is received, the system will generate or modify a composition comprising various segments in a manner similar to when only a single track is present. When the user switches to non-gesture inputs, such as when the mouse button is released, the various parallel segments can be explored. It should be noted that when a plurality of tracks is provided, the playback sequence of the separate tracks need not remain synchronized or be treated equally once gesture-modified playback beings. For example, to increase the aggressive nature of a piece, the volume of a percussion part can be increased while playback of the remaining parts.

Various techniques will be know to those of skill in the art to provide play of multiple audio parts simultaneously and to variably mix the strength of each part in the audio output. However, because realtime processing of multiple audio files can be computationally intense, a home computer may not have sufficient resources to handle more than one or two parts. In this situation, the various parts can be pre-processed to provide a number of pre-mixed tracks, each of which corresponds to a specific area on the screen. For example, the display can be divided into a 4×4 matrix and 16 separate tracks provided.

The present inventive concepts have been discussed with regards t gesture based selection of audio segments, with specific regard for music. However, the present invention is not limited to purely musical-based applications but can be applied to the selection and/or modification of any type of media files. Thus, the gesture-based system can be used to select and modify media segments generally, which segments can be directed to video data, movies, stories, real-time generated computer animation, etc.

The above described gesture interpretation method and system can be used as part of a selection device used to enable the selection of one or more items from a variety of different items which are amenable to being grouped or categorized according to emotional content. Audio and other media segments are simply one example of this. In a further alternative embodiment, a gesture interpretation system is implemented as part of a stand-alone or Internet based catalog. A gesture input module is provided to receive user input and output a gesture interpretation. For an Internet-based implementation, the gesture input module and associated support code can be based largely on the server side with a Java or ActiveX applet, for example, provided to the user to capture the raw gesture data and transmit it in raw or partially processed form to the server for analysis. The entire interpretation module could also be provided to the client and only final interpretations returned to the server. The meaning attributed to a received gesture is then used to select specific items to present to the user.

For example, a gesture interpretation can be used to generate a list of music or video albums which are available for rent or purchase and which have an emotional quality corresponding to the gesture. In another implementation, the gesture can be sued to select clothing styles, individual clothing items, or even complete outfits which match a specific mood corresponding to the gesture. A similar system can be used to for decorating, wherein the interpretation of a received gesture is used to select specific decorating styles, types of furniture, color schemes, etc., which correspond to the gesture, such as cal, excited agitated, and the like.

In yet a further implementation, gesture-based interface can be integrated into a device with customizable settings or operating parameters wherein a gesture interpretation is used to adjust the configuration accordingly. In a specific application, the Microsoft Windows™ “desktop settings” which define the color schemes, font types, and audio cues used by the windows operating system can be adjusted. In conventional systems, these settings are set by user using standard pick-and-choose option menus. While various packaged settings or “themes” are provided, the user must still manually select a specific theme. According t this aspect of the invention, the user can select a gesture-input option and enter one or more gestures. The gestures are interpreted and an appropriate set of desktop settings is retrieved or generated. In this manner, a user can easily and quickly adjust the computer settings to provide for a calming display, an exciting display, or anything in between. Moreover, the system is not limited to predefined themes but can vary any predefined themes which are available, perhaps within certain predefined constraints, to more closely correspond with a received gesture.

While the invention has been particularly shown and described with reference to preferred embodiments thereof, it will be understood by those skilled in the art that various changes in form and details may be made therein without departing from the spirit and scope of the invention. The embodiments described herein are not intended to be exhaustive or to limit the invention to the precise forms disclosed herein. Similarly, any process steps described herein may be interchangeable with other steps to achieve substantially the same result. All such modifications are intended to be encompassed within the scope of the invention, which is defined by the following claims and their equivalents.

I/We claim:

1. An interactive music method comprising the steps of:
receiving a gesture;
interpreting the gesture in accordance with a plurality of predefined gestures;
assigning an emotional meaning to the gesture; and
playing music according to the assigned emotional meaning.

2. The method of claim 1 wherein the gesture is interpreted by scaling the gesture into a value indicating a group of parameters selected from the group consisting of bentness, jerkiness and length of the gesture.

3. The method of claim 1 wherein the gesture is received by an input device selected from the group consisting of a mouse, joystick, trackball, tablet, data gloves, electronic conducting baton, video motion tracking device, blood pressure tracking device, heart rate tracking device and muscle tracking device.

4. The method of claim 3 further comprising the steps of:
calculating a duration of time between when the mouse is up and when the mouse is down;
calculating a number of pixels traveled by the mouse;
calculating variations in a velocity of the mouse within the gesture; and
calculating an arm of the mouse movement throughout the gesture.

5. The method of claim 2 further comprising the steps of:
calculating a number and location of horizontal and vertical direction changes in the gesture; and
determining a bentness of the gesture according to the calculated number and location.

6. The method of claim 5 further comprising the step of scaling the bentness with reference to a number of bends per unit length.

7. The method of claim 1 further comprising the step of valuing the received gesture according to a three-tier scale including little bentness, medium bentness and very bent.

8. The method of claim 1 further comprising the step of valuing the received gesture according to a three-tier scale including little jerkiness, some jerkiness and very jerky.

9. The method of claim 2 further comprising the steps of:
mapping the parameters to the predefined gestures; and
associating the mapped parameters with corresponding emotional meanings.

10. The method of claim 1 wherein the interpreting step includes different levels of responsiveness to the received gesture.

11. The method of claim 10 further comprising the step of adjusting the responsiveness to the received gesture.

12. The method of claim 10 wherein the levels of responsiveness comprise a DJ mode and a simple composition mode.

13. The method of claim 1 further comprising the steps of:
storing a plurality of musical segments in database;
associating the musical segments with the predefined gestures;
selecting one of the musical segments according to the emotional meaning assigned to the received gesture; and
playing the selected musical segment.

14. The method of claim 13 further comprising the steps of:
randomly selecting one of the musical segments corresponding to the emotional meaning; and
playing the randomly selected musical segment.

15. The method of claim 13 further comprising the step of playing a predefined sequence if more than one of the musical segments correspond to the assigned emotional meaning.

16. An interactive music system comprising:
a receiver receiving a gesture;
an interpreter device interpreting the gesture in accordance with a plurality of predefined gestures;
an assignor device assigning an emotional meaning to the gesture; and
a playback device playing music according to the assigned emotional meaning.

17. The system of claim 16 wherein the gesture is interpreted by scaling the gesture into a value indicating a group of parameters selected from the group consisting of bentness, jerkiness and length of the gesture.

18. The system of claim 16 wherein the gesture is received by an input device selected from the group consisting of a mouse, joystick, trackball, tablet data gloves, electronic conducting baton, video motion tracking device, blood pressure tracking device, heart rate tracking device and muscle tracking device.

19. The system of claim 18 further comprising:
a calculator calculating a duration of time between when the mouse is up and when the mouse is down, calculating a number of pixels traveled by the mouse, calculating variations in a velocity of the mouse within the gesture, and calculating an arm of the mouse movement throughout the gesture.

20. The system of claim 17 further comprising:
a calculator calculating a number and location of horizontal and vertical direction changes in the gesture; and
the system determining a bentness of the gesture according to the calculated number and location.

21. The system of claim 20 further comprising a scalar device scaling the bentness with reference to a number of bends per unit length.

22. The system of claim 16 wherein the system values the received gesture according to a three-tier scale including little bentness, medium bentness and very bent.

23. The system of claim 16 wherein the system values the received gesture according to a three-tier scale including little jerkiness, some jerkiness and very jerky.

24. The system of claim 17 further comprising:
a mapper mapping the parameters to the predefined gestures; and
the system associating the mapped parameters with corresponding emotional meanings.

25. The system of claim 16 wherein the interpreter device interprets the gesture according to different levels of responsiveness to the received gesture.

26. The system of claim 25 further comprising an adjustor device adjusting the responsiveness to the received gesture.

27. The system of claim 25 wherein the levels of responsiveness comprise a DJ mode and a simple composition mode.

28. The system of claim 16 further comprising:
a database storing a plurality of musical segments wherein the musical segments are associated with the predefined gestures; and
a selector device selecting one of the musical segments according to the emotional meaning assigned to the received gesture wherein the playback device plays the selected musical segment.

29. The system of claim 28 further comprising a random selector randomly selecting one of the musical segments corresponding to the emotional meaning wherein the playback device plays the randomly selected musical segment.

30. The system of claim 28 wherein a predefined sequence is played if more than one of the musical segments correspond to the assigned emotional meaning.
